(19) United States
(12) Patent Application Publication
(10) Pub. No.: US 2026/0358829 A1
(43) Pub. Date: Nov. 12, 2026

(54) HIERARCHICAL RESPONSE DRONE SWARM SYSTEMS AND METHODS

(71) Applicant: State Farm Mutual Automobile Insurance Company, Bloomington, IL (US)

(72) Inventor: Alex O'Neill, Bloomington, IL (US)

(21) Appl. No.: 19/205,526

(22) Filed: May 12, 2025

(51) Int. Cl. G05D 1/69; G05B 13/02; G05D 1/246; G05D 105/28; G05D 109/25

(52) U.S. Cl. CPC G05D 1/69; G05B 13/0265; G05D 1/2465; G05D 2105/28; G05D 2109/254

(57) ABSTRACT

A response system that utilizes a hierarchically-organized drone swarm may be provided. The response system may include a base computing device configured to (i) receive sensor data from a plurality of relay drones, the sensor data generated by sensors of the plurality of on-site drones; (ii) generate a three dimensional map based upon the sensor data using an artificial intelligence (AI) model, the AI model configured to identify a location of one or more features based upon the sensor data, wherein the AI model is trained based upon historical sensor data and historically identified features; and (iii) transmit the generated three dimensional map including the identified location of the one or more features to the plurality of relay drones, wherein each of the plurality of relay drones is configured to generate and transmit instructions based upon the generated three dimensional map.

### FIELD OF THE DISCLOSURE

The field of the disclosure relates generally to artificial intelligence (AI) and drone systems, and more specifically, to a drone system utilizing a drone swarm organized in a hierarchical control scheme and controlled using one or more AI models.

### BACKGROUND

Unmanned aerial vehicles, or drones, are used in a variety of applications. In particular, drones are often used for collecting data such as video or other images. This makes drones useful for many different types of responses including disaster response situations, because drones may access and provide perspectives from areas not easily accessible by humans. However, certain challenges exist in utilizing drones in a disaster response situation. For example, disasters may occur in remote locations or locations that are otherwise not easily accessible. This poses challenges, for example, in establishing a reliable communication link with the drones for the purposes of controlling the drones, decision making processes involving the drones, and being able to operate the drones for a long period of time without exhausting a supply of power. While in some cases autonomous drones are used, these drones are limited in capability to their own local processing power.

Conventional systems may include additional ineffectiveness, encumbrances, inefficiencies, and/or other drawbacks as well.

### BRIEF DESCRIPTION OF THE DISCLOSURE

The present embodiments may relate to, inter alia, artificial intelligence (AI)-based response systems and methods that use a hierarchically-organized drone swarm. In an exemplary embodiment, the response system may be used in a disaster application. Thus, in this case, the response system may also be referred to as a disaster response system.

In the exemplary embodiment, the response system may include a first plurality of drones, referred to herein as “on-site” drones, and a second plurality of drones, referred to herein as “relay” drones. Each of the on-site drones is configured to perform specific roles at a disaster site or other emergency response site, such as collecting data, performing or assisting in rescue operations, providing support to other drones (e.g., by supplying battery charge), and/or other actions involving interaction with the disaster site. Each one of the relay drones may be in communication with one or more of the on-site drones. The relay drones may generate and transmit instructions for controlling the at least one of the relay drones. In other words, certain types of higher-level decision-making, such as determining a flight path for the on-site drones, may be performed by the relay drones rather than the on-site drones themselves.

In the example embodiment, the response system may further include at least one base computing device that is in communication with the plurality of relay drones. The base computing device may be configured to train an execute an AI model, which may be used for controlling the relay drones and the on-site drones. The base computing device may be configured to receive sensor data generated by the on-site drones and/or relay drones. This sensor data may be transmitted to the base computing device by the relay drones that are in communication with the base computing device. The base computing device may generate a three dimensional map based upon the sensor data using an AI model. The three dimensional map may include static features, such as a topography of the disaster site and locations of roads, natural features, and structures, as well as dynamic features such as locations of people, vehicles, and objects and/or debris that may have moved as a result of the disaster. The AI model is configured to identify a location of these features based upon the sensor data, and may be trained based upon historical sensor data and historically identified features. The base computing device may transmit the generated three dimensional map to the relay drones, which may then generate and transmit the instructions based upon the generated three dimensional map.

In at least one embodiment, the response system may utilize a hierarchically-organized drone swarm. The response system may include a first plurality of drones and a second plurality of drones, wherein each one of the second plurality of drones is (i) in communication with at least one of the first plurality of drones, and (ii) configured to generate and transmit instructions for controlling the at least one of the first plurality of drones. The response system may further include one or more local or remote computers, processors, servers, sensors, transceivers, mobile devices, wearables, smart watches, smart contact lenses, voice bots, chat bots, AI (e.g., ChatGPT) bots, augmented reality glasses, virtual reality headsets, mixed or extended reality headsets or glasses, and other electronic or electrical components, which may be in wired or wireless communication with one another, and operate as input and/or output devices. For example, in one instance, the response system may include a base computing device including one or more processors programmed to: (a) receive sensor data from the second plurality of drones, the sensor data generated by sensors of the first plurality of drones; (b) generate a three dimensional map based upon the sensor data using an AI model, the AI model configured to identify a location of one or more features based upon the sensor data, wherein the AI model is trained based upon historical sensor data and historically identified features; and (c) transmit the generated three dimensional map including the identified location of the one or more features to the second plurality of drones, wherein each of the second plurality of drones is configured to generate and transmit the instructions based upon the generated three dimensional map. The response system may include additional, less, or alternate functionality, including that discussed elsewhere herein.

In another embodiment, a computer-implemented method for operating a response system that utilizes a hierarchically-organized drone swarm may be provided. The response system may include a first plurality of drones and a second plurality of drones, wherein each one of the second plurality of drones is (i) in communication with at least one of the first plurality of drones, and (ii) configured to generate and transmit instructions for controlling the at least one of the first plurality of drones. The method may be implemented using one or more local or remote processors, servers, sensors, transceivers, mobile devices, wearables, smart watches, smart contact lenses, voice bots, chat bots, AI (e.g., ChatGPT) bots, augmented reality glasses, virtual reality headsets, mixed or extended reality headsets or glasses, and other electronic or electrical components, which may be in wired or wireless communication with one another, and operate as input and/or output devices. For example, the method may include: (a) receiving, by a base computing device, sensor data from the second plurality of drones, the sensor data generated by sensors of the first plurality of drones; (b) generating, by the base computing device, a three dimensional map based upon the sensor data using an AI model, the AI model configured to identify a location of one or more features based upon the sensor data, wherein the AI model is trained based upon historical sensor data and historically identified features; and (c) transmitting, by the base computing device the generated three dimensional map including the identified location of the one or more features to the second plurality of drones, wherein each of the second plurality of drones is configured to generate and transmit the instructions based upon the generated three dimensional map. The computer-implemented method may include additional, less, or alternate actions, including those discussed elsewhere herein.

In still another embodiment, at least one non-transitory computer-readable media having computer-executable instructions embodied thereon for operating a response system that utilizes a hierarchically-organized drone swarm may be provided. The response system may include a plurality of on-site drones and a plurality of relay drones, wherein each one of the plurality of relay drones is (i) in communication with at least one of the plurality of on-site drones, and (ii) configured to generate and transmit instructions for controlling the at least one of the plurality of on-site drones. The computer-executable instructions may be implemented using one or more local or remote processors, servers, sensors, transceivers, mobile devices, wearables, smart watches, smart contact lenses, voice bots, chat bots, AI (e.g., ChatGPT) bots, augmented reality glasses, virtual reality headsets, mixed or extended reality headsets or glasses, and other electronic or electrical components, which may be in wired or wireless communication with one another, and operate as input and/or output devices. For example, when executed by at least one processor, the computer-executable instructions cause the at least one processor to: (a) receive sensor data from the plurality of relay drones, the sensor data generated by sensors of the plurality of on-site drones; (b) generate a three dimensional map based upon the sensor data using an AI model, the AI model configured to identify a location of one or more features based upon the sensor data, wherein the AI model is trained based upon historical sensor data and historically identified features; and (c) transmit the generated three dimensional map including the identified location of the one or more features to the plurality of relay drones, wherein each of the plurality of relay drones is configured to generate and transmit the instructions based upon the generated three dimensional map. The computer readable media may have instructions that direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a diagram of an exemplary customized response system that utilizes a hierarchically-organized drone swarm in accordance with at least one embodiment of the present disclosure.

FIG. 2A is a top view of an exemplary drone in accordance with at least one embodiment of the present disclosure.

FIG. 2B is a side view of the exemplary drone shown in FIG. 2A.

FIG. 3A is a top view of another exemplary drone in accordance with at least one embodiment of the present disclosure.

FIG. 3B is a side view of the exemplary drone shown in FIG. 3A.

FIG. 4A is a top view of another exemplary drone in accordance with at least one embodiment of the present disclosure.

FIG. 4B is a side view of the exemplary drone shown in FIG. 4A.

FIG. 5A is a top view of another exemplary drone in accordance with at least one embodiment of the present disclosure.

FIG. 5B is a side view of the exemplary drone shown in FIG. 5A.

FIG. 6A is a top view of another exemplary drone in accordance with at least one embodiment of the present disclosure.

FIG. 6B is a side view of the exemplary drone shown in FIG. 6A.

FIG. 7A is a top view of another exemplary drone in accordance with at least one embodiment of the present disclosure.

FIG. 7B is a side view of the exemplary drone shown in FIG. 7A.

FIG. 8 is a diagram of a disaster scene in which the response system shown in FIG. 1 and/or the drones shown in FIGS. 2A-7B may be deployed in accordance with at least one embodiment of the present disclosure.

FIG. 9 illustrates an exemplary client computing device in accordance with at least one embodiment of the present disclosure.

FIG. 10 illustrates an exemplary server computing device in accordance with at least one embodiment of the present disclosure.

FIG. 11 illustrates an exemplary base computing device in accordance with at least one embodiment of the present disclosure.

FIG. 12A illustrates a flow chart of an exemplary computer-implemented method for operating a response system that utilizes a hierarchically-organized drone swarm that may be implemented by the system shown in FIG. 1 in accordance with at least one embodiment of the present disclosure.

FIG. 12B is a continuation of the flow chart shown in FIG. 12A.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION OF THE DISCLOSURE

The present embodiments may relate to, inter alia, artificial intelligence (AI)-based response systems and methods that use a hierarchically-organized drone swarm. In the exemplary embodiment, the AI-based response systems and methods may be used in a disaster application. Thus, in this case, the AI-based response systems and methods may also be referred to as an AI-based disaster response system and method.

In an exemplary embodiment, the response system may include a first plurality of drones, referred to herein as “on-site” drones, and a second plurality of drones, referred to herein as “relay” drones. Each of the on-site drones is configured to perform specific roles at a disaster site or other emergency response site, such as collecting data, performing or assisting in rescue operations, providing support to other drones (e.g., by supplying battery charge), and/or other actions involving interaction with the disaster site. Each one of the relay drones may be in communication with one or more of the on-site drones. The relay drones may generate and transmit instructions for controlling the on-site drones. In other words, certain types of higher-level decision-making, such as determining a flight path for the on-site drones, may be performed by the relay drones rather than the on-site drones themselves.

In the example embodiment, the response system may further include at least one base computing device that is in communication with the plurality of relay drones. The base computing device may be land-based, and accordingly, may have greater processing and storage capabilities than drone-based computing devices due to the base computing device not being subject to the space, weight, and energy usage limitations necessary for implementing a computing device onboard a drone.

The base computing device may be configured to train an execute an AI model, which may be used for controlling the relay drones and the on-site drones. The base computing device may be configured to receive sensor data generated by the on-site drones and/or relay drones. This sensor data may be transmitted to the base computing device by the relay drones that are in communication with the base computing device. The base computing device may generate a three dimensional map based upon the sensor data using an AI model. The three dimensional map may include static features, such as a topography of the disaster site and locations of roads, natural features, and structures, as well as dynamic features such as locations of people, vehicles, and objects and/or debris that may have moved as a result of the disaster. The AI model is configured to identify a location of these features based upon the sensor data, and may be trained based upon historical sensor data and historically identified features.

The base computing device may transmit the generated three dimensional map to the relay drones, which may then generate and transmit the instructions based upon the generated three dimensional map. Accordingly, by leveraging the processing power of the base computing device and establishing a continuous communication connection between the base computing device, the relay drones, and the on-site drones, the relay drones and the on-site drones may benefit from AI-based control without needing to execute computationally-expensive AI algorithms locally.

In exemplary embodiments, the on-site drones may include drones of different types or configurations that correspond to different roles within the disaster site. One example, referred to herein as a “scout drone,” may include an array of sensors such as cameras, radar sensors, lidar sensors, microphones, audio sensors, chemical sensors, electrical sensors, thermal sensors, and/or other sensors that may detect conditions at the disaster site. In particular, the sensor data generated by scout drones may be capable of detecting people such as those who may have become trapped or otherwise unable to remove themselves from the disaster site.

Another example of an on-site drone, referred to herein as a “relief drone,” may include mechanical devices, such as mechanical arms and/or claws, that enable the relief drone to interact with the environment at the disaster site, such as by clearing debris or providing first aid. The relief drone may be further capable of carrying and delivering a payload such as water, food, tools, and/or first aid materials.

A further example of an on-site drone, referred to herein as an “energy supply drone,” which may be configured to supply charge or energy to other on-site drones and/or relay drones. For example, the energy supply drone may be configured to physically exchange or hot-swap batteries with other drones to replace depleted batteries with charged batteries, and/or may electrically couple with other drones to provide a supply or charge without physically swapping batteries. The energy supply drones may include local power generating devices such as solar panels to replenish their own charge and/or to charge batteries that can be swapped to other drones.

An additional example of an on-site drone, referred to as an “observer drone” may be configured to follow any other on-site drones, and may include additional sensors (e.g., 360 degree video and audio sensors) to supplement the sensor capabilities of any followed on-site drones.

Each of the on-site drones may be in communication with at least one relay drone that is present at the site, and may be configured to control operation by receiving instructions (e.g., flight paths and/or instructions to perform predefined routines) from the relay drone. As described in further detail below, the relay drone may generate these instructions based on a three dimensional map that may be updated in real time by the base computing device using an AI model. The relay drones may communicate with the base computing device via a direct wireless connection, via cellular and/or other terrestrial or satellite-based communication networks, and/or through one or more intermediate drones. For example, the response system may include one or more dedicated drones, referred to herein as “uplink drones,” that are configured to relay signals between the relay drones and a satellite network or other communication network.

In some embodiments, the relay drones may include sensors capable of tracking locations of on-site drones and/or aspects of the environment of the disaster site. For example, a relay drone may detect an area of interest using its own sensors and then control one or more on-site drones to move to the area of interest and collect additional data. In some example implementations, the relay drones may be relatively large compared to the on-site drones and/or configured to collect data over a relatively wide area. In these cases, the relay drones may be capable of carrying one or more on-site drones to the disaster site and deploying the on-site drones once the relay drone has reached the disaster site.

The base computing device may be mobile or stationary, or may be implemented using multiple computing devices including both mobile or stationary computing devices with certain functions split between the different devices. For example, in some embodiments, at least a portion of the base computing device may be implemented onboard a land-based vehicle that is in communication with a server. This land-based vehicle may also be capable of carrying the relay drones and/or on-site drones to the disaster site and deploying the relay drones and/or on-site drones. In such embodiments, certain functions, such as generating a three dimensional map based upon sensor data using an AI model, may be performed by computing components executed onboard the vehicle, while other functions, such as training and updating the AI model and transmitting the AI model to the computing components onboard the vehicle, may be performed by the server.

The base computing device may be configured to receive sensor data from relay drones. This sensor data may be generated by sensors of the on-site drones and may further be generated by sensors of the relay drones in cases in which one or more of the relay drones include sensors configured to detect aspects of the environment of the disaster site. This data may include images (e.g., still images and/or video), audio, radar data, lidar data, temperature measurements, air quality measurements, electrical or electromagnetic measurements, and/or any other data descriptive of the environment of the disaster site.

The base computing device may be further configured to generate a three dimensional map based upon the sensor data and transmit the generated three dimensional map to the relay drones. The three dimensional map may include a digital representation of the disaster site. For example, the three dimensional map may include locations of static features, such as a topography of the disaster site, roads, natural features, and structures, as well as locations of dynamic features such as people, vehicles, and objects and/or debris that may have moved as a result of the disaster. In particular, locations identified as being associated with dangerous conditions or individuals in need of rescue or medical attention may be included in the three dimensional map to assist in response operations by drones and/or emergency responders.

This representation may be used by the relay drones to control their own operation and to generate instructions for controlling operation of the on-site drones. For example, the drones may use the three dimensional map to generate and/or modify flight paths that do not collide with objects or terrain and/or that move the drones into areas of interest (e.g., areas with a person in need of aid and/or areas identified as benefitting from further collection of data). In some embodiments, the drones may operate completely autonomously based upon the received three dimensional map, while in other embodiments, the drones may be controlled based at least in part on part on human input.

The base computing device may generate the three dimensional map using an AI model. The AI model may be configured to identify a location of one or more features based upon input sensor data. For example, the AI model may include and/or be capable of identifying certain correlations between sensor data and features. In some embodiments, the AI model may be configured to tag image, sound, other types of computer-readable files based upon these identified features, and the three dimensional map be generated and/or updated based upon these tags.

The AI model may be trained based upon historical sensor data and historically identified features. For example, the AI model may be trained using historical image, sound, other types of computer-readable files that are tagged with features manually, by a previous iteration of the AI model, and/or by another AI model. In some cases, the AI model may be further trained based on historical iterations of three dimensional maps generated based upon the historical sensor data and historically identified features. In certain embodiments, the AI model may be periodically or continuously updated and refined based upon newly available data, which may include sensor data received from the drones and features identified by the AI model. The AI model may be trained locally by the base computing device and/or be trained at a different location and transferred to the base computing device. For example, in some embodiments, a server may be in communication with a plurality of base computing devices and may train and provide the AI model to each of the plurality of base computing devices. In such example, the AI model may be trained by the server based upon data received from each of the plurality of based computing devices.

The base computing device may be further in communication with one or more user computing devices through which the base computing device may provide information to emergency responders or other individuals evaluating the disaster site. The user computing device may be, for example, a personal computer, tablet, smart phone, smart watch, smart glasses, augmented reality or virtual reality headset, and/or any other type of computing device that may be used to present information to a user (e.g., via a user interface).

The base computing device may be configured to cause the user computing device to display or present interfaces for emergency responders to navigate through the disaster site, for example, to reach individuals in need of rescue or medical attention while avoiding hazards. These interfaces may be generated at least in part by the AI model based upon the sensor data collected by the on-site drones and/or relay drones. These interfaces may include maps with routes determined to be safe and locations of interest (e.g., locations of individuals in need or rescue or medical attention and/or hazards), annotated images of the disaster site (e.g., collected by the on-site drones and/or relay drones), audible directions, augmented reality or virtual reality overlays, alerts and/or messages indicating dangerous or changing conditions, and/or other similar interfaces. These interfaces may be updated in real time based upon sensor data received from the on-site drones and relay drones.

The base computing device may further generate site evaluation information to be displayed on by user computing device. This site evaluation information may be generated, for example, by the AI model based upon sensor data received from the on-site drones and/or relay drones. This site evaluation information may include, for example, estimates of damage or repair costs, estimated timelines for the disaster (e.g., times when specific events occurred), predictions of what caused certain types of damage, generating recommendations for responding to the disaster, and/or other predictions relating to the disaster or disaster site. This information may be used, for example, by insurance entities for processing claims and/or determining future insurance premiums, to individuals for understanding risks to themselves or their property, and/or by government entities for planning and preparing for future disaster response operations.

The base computing device may be further in communication with a plurality of external data sources that provide external data (e.g., data generated or collected by people and/or devices not part of response system). These external data sources may include, for example, devices carried by emergency responders, smart home devices located at the disaster site, security cameras or other sensors located at the disaster site, external databases (e.g., including mapping data, weather data, or other data collected by external entities), or other sources that may provide information relevant to a disaster response. This external data may be used as an input to the AI model for any of the functions described with respect to the AI model described above.

At least one of the technical problems addressed by this system may include: (i) improving an ability of a drone swarm to identify features at a disaster site by utilizing an AI model; (ii) enabling a continuous communication channel to be established between drones operating at a disaster site and a base computing device executing an AI model by using one or more relay drones (iii) enabling instructions and flight paths to be generated and/or updated in real time using an AI model by establishing a continuous communication channel to be established between drones operating at a disaster site and a base computing device; and/or (iv) generating and updating user recommendations in real time for navigating and responding to a disaster site using an AI model and sensor data collected by one or more drones.

The computer-based or computer-implemented methods and computer systems described herein may be implemented (i) using computer programming or engineering techniques including computer software, firmware, hardware, or any combination or subset thereof, and/or (ii) by using one or more local or remote processors, transceivers, servers, sensors, servers, scanners, AR or VR headsets or glasses, smart glasses, wearables, smart watches, mobile devices, laptops, video game systems, and/or other electrical or electronic components, wherein the technical effects may be achieved by performing at least one of the following action or operations: (1) receive sensor data from the plurality of relay drones, the sensor data generated by sensors of the plurality of on-site drones; (2) generate a three dimensional map based upon the sensor data using an AI model, the AI model configured to identify a location of one or more features based upon the sensor data, wherein the AI model is trained based upon historical sensor data and historically identified features; and (3) transmit the generated three dimensional map including the identified location of the one or more features to the plurality of relay drones, wherein each of the plurality of relay drones is configured to generate and transmit the instructions based upon the generated three dimensional map.

### Exemplary Response System

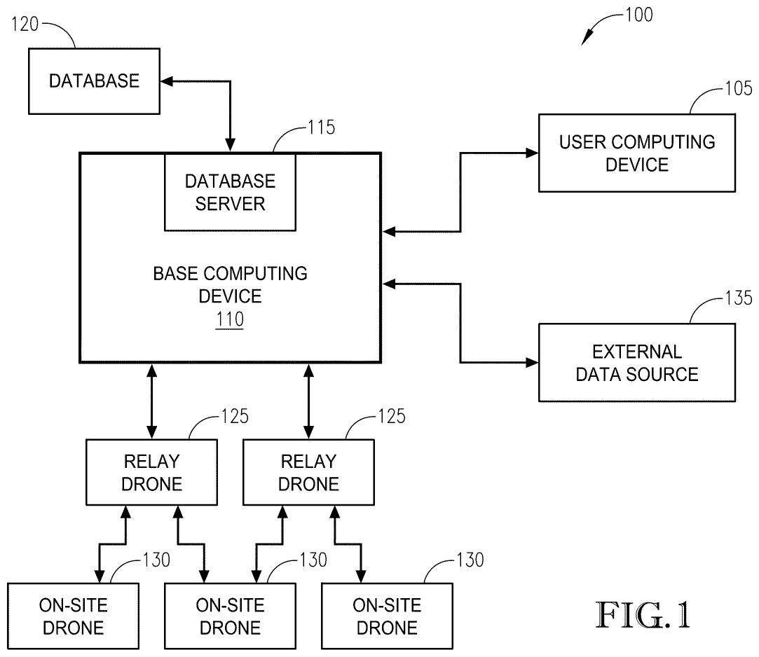

FIG. 1 illustrates a simplified block diagram of an exemplary response system 100. Response system 100 includes one or more user computing devices 105, a base computing device 110, a database server 115, a database 120, a plurality of relay drones 125, a plurality of on-site drones 130, and/or one or more external data sources 135.

In the exemplary embodiment, user computing devices 105 are computers that include a web browser or a software application, which enables user computer devices 105 to access base computing device 110 using the Internet. More specifically, user computing devices 105 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computing devices 105 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), smart glasses, a kiosk, chat bots, or other web-based connectable equipment or mobile devices.

A database server 115 may be communicatively coupled to a database 120 that stores data. In one embodiment, database 120 may include historical sensor data, historically identified features, map data, and/or any other type of data described herein. In the exemplary embodiment, database 120 may be stored remotely from base computing device 110. In some embodiments, database 120 may be decentralized. In the exemplary embodiment, a person may access database 120 via user computing devices 105 by logging onto base computing device 110 as described herein.

Base computing device 110 may be communicatively coupled with one or more user computing devices 105, relay drones 125, and/or external data sources 135. In some embodiments, base computing device 110 may be associated with, or is part of a computer network associated with business, or in communication with the business'computer network (not shown). In other embodiments, base computing device 110 may be associated with a third party and is merely in communication with the business'computer network.

Relay drones 125 may be communicatively coupled with base computing device 110 and on-site drones 130. As described in further detail below, relay drones 125 may generate and transmit instructions for controlling on-site drones 130 and may relay sensor data collected by on-site drones 130 to base computing device 110. In the example embodiment, relay drones 125 and on-site drones 130 may be capable of operating at least partially autonomously (e.g., by performing actions initiated internally and/or not based on instructions received externally).

In exemplary embodiments, on-site drones 130 may include drones of different types or configurations that correspond to different roles within the disaster site. One example, referred to herein as a “scout drone,” may include an of sensors such as cameras, radar sensors, lidar sensors, microphones, audio sensors, chemical sensors, electrical sensors, thermal sensors, and/or other sensors that may detect conditions at the disaster site. In particular, the sensor data generated by scout drones may be capable of detecting people such as those who may have become trapped or otherwise unable to remove themselves from the disaster site.

Another example of an on-site drone 130, referred to herein as a “relief drone,” may include mechanical devices, such as mechanical arms and/or claws, that enable the relief drone to interact with the environment at the disaster site, such as by clearing debris or providing first aid. The relief drone may be further capable of carrying and delivering a payload such as water, food, tools, and/or first aid materials.

A further example of an on-site drone 130, referred to herein as an “energy supply drone,” which may be configured to supply charge or energy to other on-site drones 130 and/or relay drones 125. For example, the energy supply drone may be configured to physically exchange hot-swap batteries with other drones to replace depleted batteries with charged batteries, and/or may electrically couple with other drones to provide a supply or charge without physically swapping batteries. The energy supply drones may include local power generating devices such as solar panels to replenish their own charge and/or to charge batteries that can be swapped to other drones.

An additional example of an on-site drone 130, referred to as an “observer drone” may be configured to follow any other on-site drones 130, and may include additional sensors (e.g., 360 degree video and audio sensors) to supplement the sensor capabilities of any followed on-site drones 130.

Each of the on-site drones 130 may be in communication with at least one relay drone 125 that is present at the site, and may be configured to control operation by receiving instructions (e.g., flight paths and/or instructions to perform predefined routines) from the relay drone 125. As described in further detail below, relay drones 125 may generate these instructions based on a three dimensional map that may be updated in real time by base computing device 110 using an AI model. Relay drones 125 may communicate with base computing device 110 via a direct wireless connection, via cellular and/or other terrestrial or satellite-based communication networks, and/or through one or more intermediate drones. For example, response system 100 may include one or more dedicated drones, referred to herein as “uplink drones,” that are configured to relay signals between relay drones 125 and a satellite network or other communication network.

In some embodiments, relay drones 125 may include sensors capable of tracking locations of on-site drones 130 and/or aspects of the environment of the disaster site. For example, a relay drone 125 may detect an area of interest using its own sensors and then control one or more on-site drones 130 to move to the area of interest and collect additional data. In some example implementations, relay drones 125 may be relatively large compared to on-site drones 130 and/or configured to collect data over a relatively wide area. In these cases, relay drones 125 may be capable of carrying one or more on-site drones 130 to the disaster site and deploying these on-site drones 130 once the relay drone 135 has reached the disaster site.

Base computing device 110 may be mobile or stationary, or may be implemented using multiple computing devices including both mobile or stationary computing devices with certain functions split between the different devices. For example, in some embodiments, at least a portion of base computing device 110 may be implemented onboard a land-based vehicle that is in communication with a server. This land-based vehicle may also be capable of carrying relay drones 125 and/or on-site drones 130 to the disaster site and deploying these relay drones 125 and/or on-site drones 130. In such embodiments, certain functions, such as generating a three dimensional map based upon sensor data using an AI model, may be performed by computing components executed onboard the vehicle, while other functions, such as training and updating the AI model and transmitting the AI model to the computing components onboard the vehicle, may be performed by the server.

Base computing device 110 may be configured to receive sensor data from relay drones 125. This sensor data may be generated by sensors of on-site drones 130 and may further be generated by sensors of the relay drones 125 in cases in which one or more of relay drones 125 include sensors configured to detect aspects of the environment of the disaster site. This data may include images (e.g., still images and/or video), audio, radar data, lidar data, temperature measurements, air quality measurements, electrical or electromagnetic measurements, and/or any other data descriptive of the environment of the disaster site.

Base computing device 110 may be further configured to generate a three dimensional map based upon the sensor data and transmit the generated three dimensional map to relay drones 125. The three dimensional map may include a digital representation of the disaster site. For example, the three dimensional map may include locations of static features, such as a topography of the disaster site, roads, natural features, and structures, as well as locations of dynamic features such as people, vehicles, and objects and/or debris that may have moved as a result of the disaster. In particular, locations identified as being associated with dangerous conditions or individuals in need of rescue or medical attention may be included in the three dimensional map to assist in response operations by drones and/or emergency responders.

This representation may be used by relay drones 125 to control their own operation and to generate instructions for controlling operation of on-site drones 130. For example, relay drones 125 may use the three dimensional map to generate and/or modify flight paths that do not collide with objects or terrain and/or that move relay drones 125 and/or on-site drones 130 into areas of interest (e.g., areas with a person in need of aid and/or areas identified as benefitting from further collection of data). In some embodiments, relay drones 125 and/or on-site drones 130 may operate completely autonomously based upon the received three dimensional map, while in other embodiments, relay drones 125 and/or on-site drones 130 may be controlled based at least in part on part on human input.

Base computing device 110 may generate the three dimensional map using an AI model. The AI model may be configured to identify a location of one or more features based upon input sensor data. For example, the AI model may include and/or be capable of identifying certain correlations between sensor data and features. In some embodiments, the AI model may be configured to tag image, sound, other types of computer-readable files based upon these identified features, and the three dimensional map be generated and/or updated based upon these tags.

The AI model may be trained based upon historical sensor data and historically identified features. For example, the AI model may be trained using historical image, sound, other types of computer-readable files that are tagged with features manually, by a previous iteration of the AI model, and/or by another AI model. In some cases, the AI model may be further trained based on historical iterations of three dimensional maps generated based upon the historical sensor data and historically identified features. In certain embodiments, the AI model may be periodically or continuously updated and refined based upon newly available data, which may include sensor data received from relay drones 125 and/or on-site drones 130 and features identified by the AI model. The AI model may be trained locally by base computing device 110 and/or be trained at a different location and transferred to base computing device 110. For example, in some embodiments, a server may be in communication with a plurality of base computing devices 110 and may train and provide the AI model to each of the plurality of base computing devices 110. In such example, the AI model may be trained by the server based upon data received from each of the plurality of based computing devices 110.

Base computing device 110 may be further in communication with user computing devices 105 through which base computing device 110 may provide information to emergency responders or other individuals evaluating the disaster site. Base computing device 110 may be configured to cause user computing device 105 to display or present interfaces for emergency responders to navigate through the disaster site, for example, to reach individuals in need of rescue or medical attention while avoiding hazards. These interfaces may be generated at least in part by the AI model based upon the sensor data collected by the on-site drones and/or relay drones. These interfaces may include maps with routes determined to be safe and locations of interest (e.g., locations of individuals in need or rescue or medical attention and/or hazards), annotated images of the disaster site (e.g., collected by the on-site drones and/or relay drones), audible directions, augmented reality or virtual reality overlays, alerts and/or messages indicating dangerous or changing conditions, and/or other similar interfaces. These interfaces may be updated in real time based upon sensor data received from relay drones 125 and/or on-site drones 130.

Base computing device 105 may further generate site evaluation information to be displayed on by user computing device. This site evaluation information may be generated, for example, by the AI model based upon sensor data received from the on-site drones and/or relay drones. This site evaluation information may include, for example, estimates of damage or repair costs, estimated timelines for the disaster (e.g., times when specific events occurred), predictions of what caused certain types of damage, generating recommendations for responding to the disaster, and/or other predictions relating to the disaster or disaster site. This information may be used, for example, by insurance entities for processing claims and/or determining future insurance premiums, to individuals for understanding risks to themselves or their property, and/or by government entities for planning and preparing for future disaster response operations.

Base computing device 110 may be further in communication with external data sources 135 that provide external data (e.g., data generated or collected by people and/or devices not part of response system 100). External data sources 135 may include, for example, devices carried by emergency responders, smart home devices located at the disaster site, security cameras or other sensors located at the disaster site, external databases (e.g., including mapping data, weather data, or other data collected by external entities), or other sources that may provide information relevant to a disaster response. This external data may be used as an input to the AI model for any of the functions described with respect to the AI model described above.

### Exemplary Drones

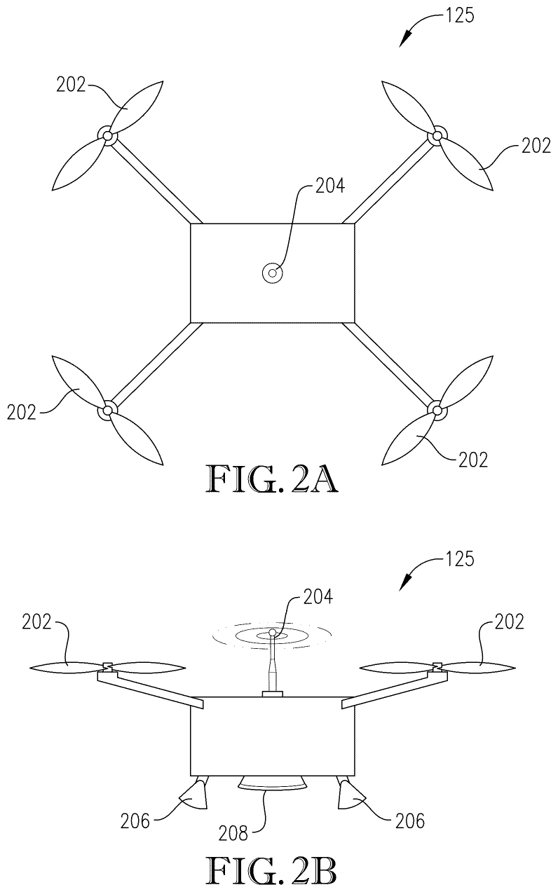

FIGS. 2A-7B depict various exemplary embodiments of relay drones 125, on-site drones 130, and/or other types of drones that may be utilized by response system 100 according to an embodiment of the present disclosure.

FIG. 2A depicts a top view of an exemplary relay drone 125, and FIG. 2B illustrates a side view of relay drone 125. Relay drone 125 may include one or more rotors 202 or other propulsion mechanisms that enable relay drones 125 to move or hover within an aerial space. Relay drone 125 may further include a first antenna 204 for communicating with base computing device 110 (shown in FIG. 1) and a second set of antennas 206 for communicating with on-site drones 130 (shown in FIG. 1). Relay drone 125 may further include one or more sensors 408, which may be used to collect data for operating relay drone 125 and/or for transmitting to base computing device 110.

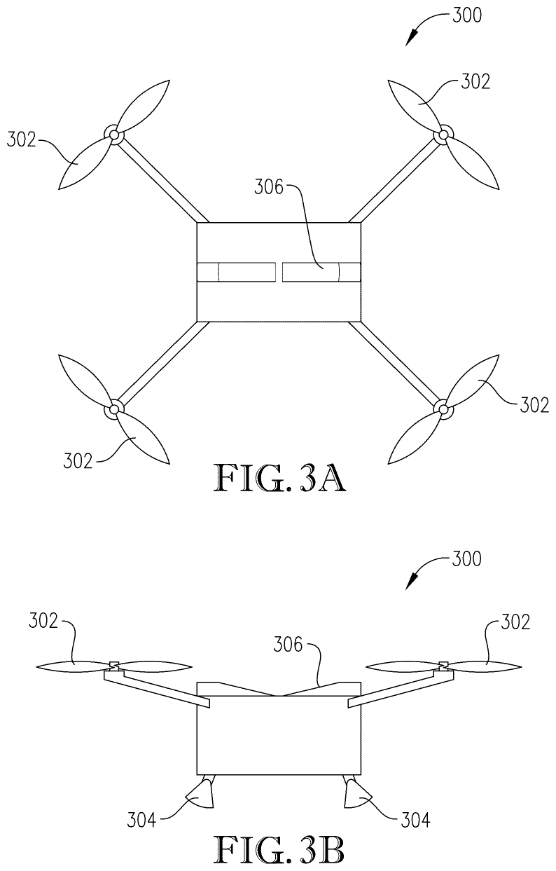

FIG. 3A depicts a top view of an exemplary uplink drone 300, and FIG. 3B illustrates a side view of uplink drone 300. Uplink drone 300 may include one or more rotors 302 or other propulsion mechanisms that enable uplink drones 300 to move or hover within an aerial space. Uplink drone 300 may further include a first set of antennas 304 for communicating with relay drones 125 and/or on-site drones 130 and a satellite antenna 306 for communicating with a satellite network. By communicating with a satellite network, uplink drone 300 may enable data from relay drones 125 and/or on-site drones 130 to be transmitted to and/or received from base computing device 110 when base computing device 110 is remote from relay drones 125 and/or on-site drones 130 or when any of base computing device 110, relay drones 125, and/or on-site drones 130 are in an area where no other communication network is available.

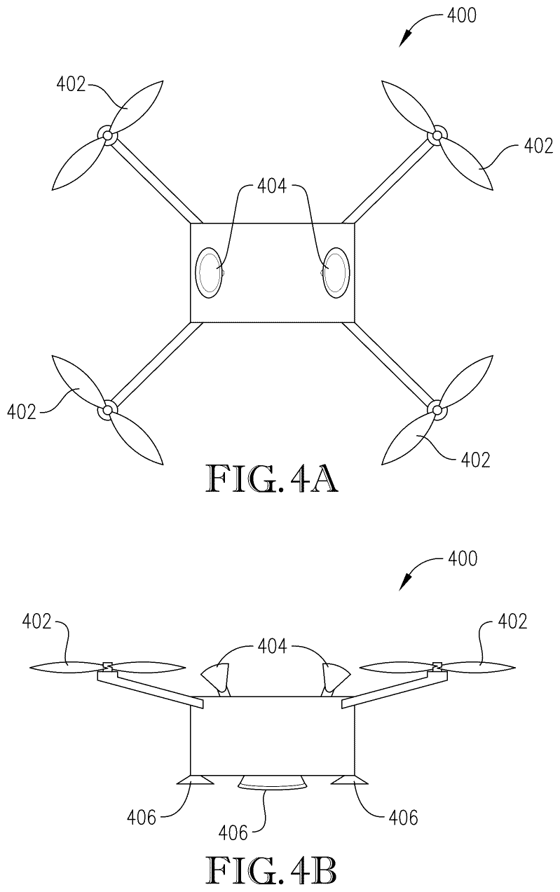

FIG. 4A depicts a top view of an exemplary scout drone 400, and FIG. 4B illustrates a side view of scout drone 400. Scout drone 400 may be one exemplary type of on-site drone 130. Scout drone 400 may include one or more rotors 402 or other propulsion mechanisms that enable scout drones 400 to move or hover within an aerial space. Scout drone 400 may further include a set of antennas 404 for communicating with relay drone 125 and/or other on-site drones 130. Scout drone 400 may further include one or more sensors 406, which may be used to collect data for operating scout drone 400 and/or for transmitting to base computing device 110 via relay drone 125.

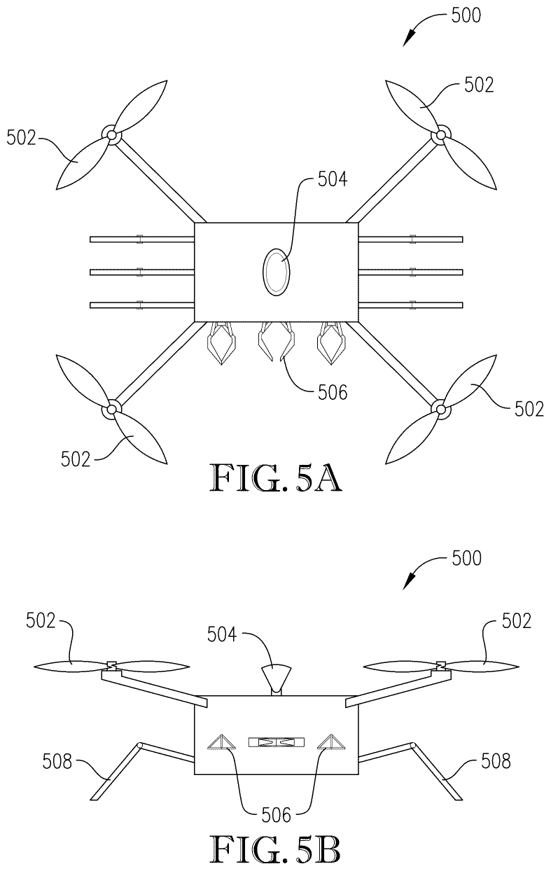

FIG. 5A depicts a top view of an exemplary relief drone 500, and FIG. 4B illustrates a side view of relief drone 500. Relief drone 500 may be one exemplary type of on-site drone 130. Relief drone 500 may include one or more rotors 502 or other propulsion mechanisms that enable relief drones 500 to move or hover within an aerial space. Relief drones 500 may further include a set of antennas 504 for communicating with relay drone 125 and/or other on-site drones 130. Relief drone 500 may further include one or more mechanical claws 506 and/or mechanical legs 508, which may enable relief drone to land and/or interact with the environment at the disaster site, such as by moving debris and/or administering first aid.

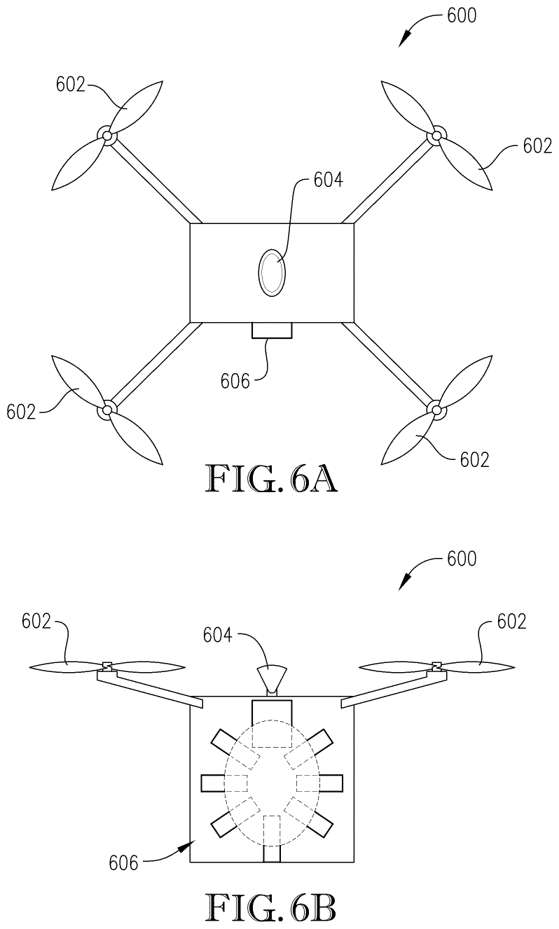

FIG. 6A depicts a top view of an exemplary energy supply drone 600, and FIG. 4B illustrates a side view of energy supply drone 600. Energy supply drone 600 may be one exemplary type of on-site drone 130. Energy supply drone 600 may include one or more rotors 602 or other propulsion mechanisms that enable energy supply drone 600 to move or hover within an aerial space. Energy supply drone 600 may further include a set of antennas 604 for communicating with relay drone 125 and/or other on-site drones 130. Energy supply drone 600 may further include a battery swapping mechanism 608 that is configured to swap the batteries of another drone (e.g., a relay drone 125 or on-site drone 130) to resupply power to the other drone. In alternative embodiments, energy supply drone 600 may be capable of charging batteries of another drone via a wired or wireless connection. In some embodiments, energy supply drone 600 may include onboard power generating devices such as solar panels for recharging batteries.

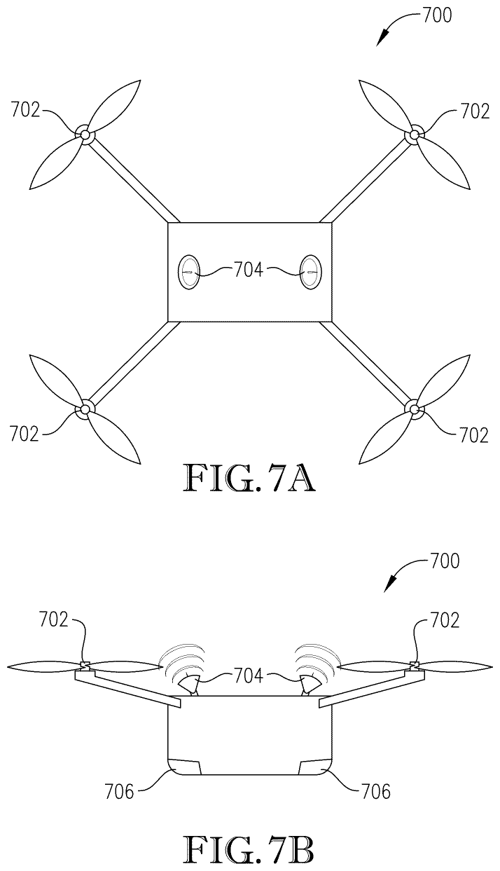

FIG. 7A depicts a top view of an exemplary observer drone 700, and FIG. 7B illustrates a side view of observer drone 700. Observer drone 700 may be one exemplary type of on-site drone 130. Observer drone 700 may include one or more rotors 702 or other propulsion mechanisms that enable observer drone 700 to move or hover within an aerial space. Observer drone 700 may further include a set of antennas 704 for communicating with relay drone 125 and/or other on-site drones 130. Observer drone 700 may further include one or more sensors 706, which may be used to collect data for operating observer drone 700 and/or on-site drones operating nearby observer drone 700 and/or for transmitting to base computing device 110 via relay drone 125.

### Exemplary Disaster Site Implementation of an AI-Based Response System

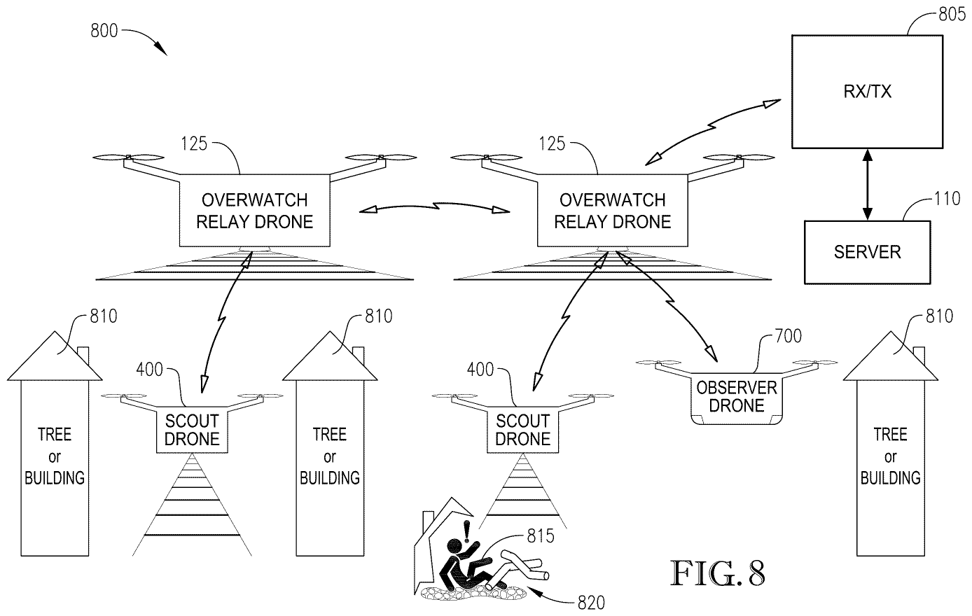

FIG. 8 is a diagram of an exemplary disaster site 800 illustrating an example implementation of portions of response system 100 (shown in FIG. 1). Base computing device 110 may communicate with relay drones 125 via a network 805. Relay drones 125 may further communicate with on-site drones 130, such as the scout drones 400 and observer drone 700 shown in FIG. 8.

Accordingly, sensor data collected by relay drones 125, scout drones 400, and/or observer drone 700 may be transmitted to base computing device 110, which may use an AI model to identify features at disaster site 800 such as trees or buildings 810, person 815, and/or rubble 820, and may generate a three dimensional map to be transmitted to relay drones 125 that includes these identified features. Using the AI model, base computing device 110 may further identify recommended actions. For example, base computing device 110 may identify that person 815 is trapped under rubble 820, and may alert a responder to a location of person 815 (e.g., using user computing device 105) and/or may cause a relief drone 500 to remove rubble 820.

### Exemplary Client Device

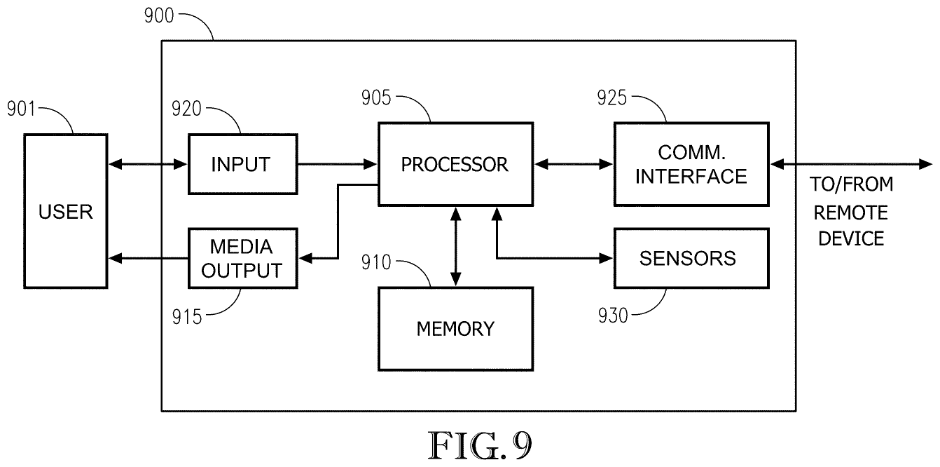

FIG. 9 depicts an exemplary configuration of a client computing device 900. Client computing device may include, but is not limited to, user computing device 105 and/or any of the other various computing devices shown in FIG. 1. Client computing device 900 may be operated by a user 901. User computing device 105 may include a processor 905 for executing instructions. In some embodiments, executable instructions are stored in a memory area 910. Processor 905 may include one or more processing units (e.g., in a multi-core configuration). Memory area 910 may be any device allowing information such as executable instructions and/or transaction data to be stored and retrieved. Memory area 210 may include one or more computer readable media.

Client computing device 900 may also include at least one media output component 915 for presenting information to user 901. Media output component 915 may be any component capable of conveying information to user 901. In some embodiments, media output component 915 may include an output adapter (not shown) such as a video adapter and/or an audio adapter. An output adapter may be operatively coupled to processor 905 and operatively couplable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets).

In some embodiments, media output component 915 may be configured to present a graphical user interface (e.g., a web browser and/or a client application) to user 901. A graphical user interface may include, for example, an online store interface for viewing and/or purchasing items, and/or a wallet application for managing payment information. In some embodiments, client computing device 900 may include an input device 920 for receiving input from user 901. User 901 may use input device 920 to, without limitation, select and/or enter one or more items to purchase and/or a purchase request, or to access credential information, and/or payment information.

Input device 920 may include, for example, a keyboard, a pointing device, a mouse, a stylus, a touch sensitive panel (e.g., a touch pad or a touch screen), a gyroscope, an accelerometer, a position detector, a biometric input device, an audio input device (e.g., a microphone), and/or a video input device (e.g., a camera). A single component such as a touch screen may function as both an output device of media output component 915 and input device 920.

Client computing device 900 may also include a communication interface 925, communicatively coupled to a remote device such as base computing device 110 (shown in FIG. 1). Communication interface 925 may include, for example, a wired or wireless network adapter and/or a wireless data transceiver for use with a mobile telecommunications network.

Stored in memory area 910 are, for example, computer readable instructions for providing a user interface to user 901 via media output component 915 and, optionally, receiving and processing input from input device 920. A user interface may include, among other possibilities, a web browser and/or a client application. Web browsers enable users, such as user 901, to display and interact with media and other information typically embedded on a web page or a website from base computing device 110. A client application allows user 901 to interact with, for example, base computing device 110. For example, instructions may be stored by a cloud service, and the output of the execution of the instructions sent to the media output component 915.

Processor 905 executes computer-executable instructions for implementing aspects of the disclosure. In some embodiments, the processor 905 is transformed into a special purpose microprocessor by executing computer-executable instructions or by otherwise being programmed.

### Exemplary Server Device

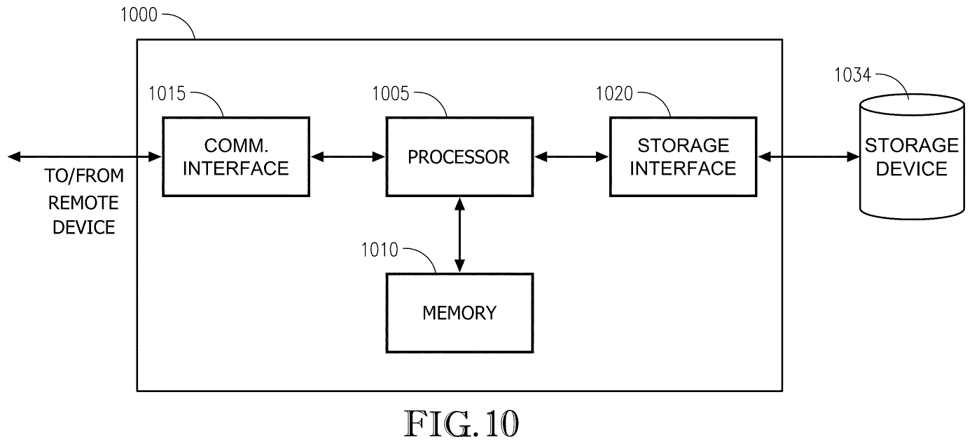

FIG. 10 depicts an exemplary configuration of a server computing device 1000, in accordance with one embodiment of the present disclosure. Server computing device 1000 may include, but is not limited to, base computing device 110 and/or any of the other various computing devices shown in FIG. 1. Server computing device 1000 may also include a processor 1005 for executing instructions. Instructions may be stored in a memory area 1010. Processor 1005 may include one or more processing units (e.g., in a multi-core configuration).

Processor 1005 may be operatively coupled to a communication interface 1015 such that server computer device 1000 is capable of communicating with a remote device such as another server computer device 1000 client computer devices 900 (shown in FIG. 9). For example, communication interface 1015 may receive requests from client computer devices 900 via the Internet.

Processor 1005 may also be operatively coupled to a storage device 1034. Storage device 1034 may be any computer-operated hardware suitable for storing and/or retrieving data, such as, but not limited to, data associated with database 120 (shown in FIG. 1). In some embodiments, storage device 1034 may be integrated in server computer device 1000. For example, server computer device 1000 may include one or more hard disk drives as storage device 1034.

In other embodiments, storage device 1034 may be external to server computer device 1000 and may be accessed by a plurality of server computer devices 1000. For example, storage device 1034 may include a storage area network (SAN), a network attached storage (NAS) system, and/or multiple storage units such as hard disks and/or solid state disks in a redundant array of inexpensive disks (RAID) configuration.

In some embodiments, processor 1005 may be operatively coupled to storage device 1034 via a storage interface 1020. Storage interface 1020 may be any component capable of providing processor 1005 with access to storage device 1034. Storage interface 1020 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1005 with access to storage device 1034.

Processor 1005 may execute computer-executable instructions for implementing aspects of the disclosure. In some embodiments, the processor 1005 may be transformed into a special purpose microprocessor by executing computer-executable instructions or by otherwise being programmed.

### Exemplary Base Computing Device

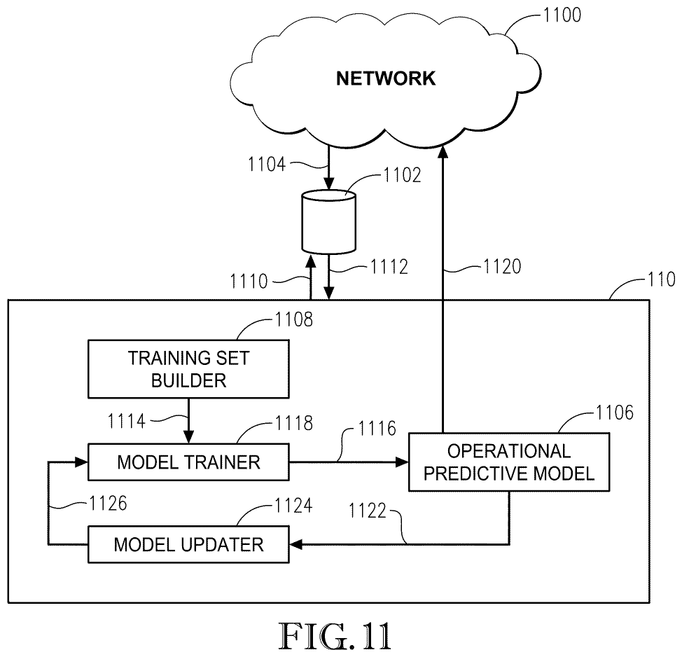

FIG. 11 is a schematic diagram illustrating further detail of base computing device 110 (shown in FIG. 1) according to an exemplary embodiment. Base computing device 110 may communicate with other components of response system 100 via a network 1100. Base computing device 110 may include and/or be in communication with a database 1102 that stores data 1104 including historical sensor data and historically identified features. Data 1104 received from network 1100 may be stored in database 1102. Base computing device 110 may configured to use data 1104 to generate an operational predictive model module 1106 for identifying features, generating three dimensional maps, and/or generating recommendations as described herein.

In exemplary embodiments, base computing device 110 includes a training set builder module 1108 configured to submit one or more queries 1110 to database 1102 to retrieve subsets 1112 of data 1104, and to use those subsets 1112 to build training data sets 1114 for generating operational predictive model 1116. For example, query 1110 may be configured to retrieve certain fields from data 1104 having certain similar aspects, such as images having common patterns or features.

In exemplary embodiments, training set builder module 1108 may be configured to derive training data sets 1114 from retrieved subsets 1112. Each training data set 1114 corresponds to a historical data 1104 (“historical” in this context means completed in the past, as opposed to completed in real-time with respect to the time of retrieval by training set builder module 1108). Each training data set 1114 may include “model input” data fields along with at least one “result” data field representing historical feedback. The model input data fields represent factors that may be expected to, or unexpectedly be found during model training to, have some correlation with data values and/or features within a disaster site.

In exemplary embodiments, the model input data fields in training data sets 1114 may be generated from data fields in subset 1112 corresponding to historical data 1104. In other words, a trained machine learning model 1116 produced by a model trainer module 1118 for use by operational predictive model module 1106 is trained to make predictions based on input values that can be generated from the data fields in data 1104. Values in the model input data fields may include values copied directly from values in a corresponding data field in the retrieved subset 1112, and/or values generated by modifying, combining, or otherwise operating upon values in one or more data fields in the retrieved subset 1112. The use of such data fields as model input data fields facilitates the machine learning model in weighing these factors directly.

After training set builder module 1108 generates training data sets 1114, training set builder module 1108 passes the training data sets 1114 to model trainer module 1118. In example embodiments, model trainer module 1118 is configured to apply the model input data fields of each training data set 1114 as inputs to one or more machine learning models. Each of the one or more machine learning models is programmed to produce, for each training data set 1114, at least one output intended to correspond to, or “predict,” a value of the at least one result data field of the training data set 1114. “Machine learning” refers broadly to various algorithms that may be used to train the model to identify and recognize patterns in existing data in order to facilitate making predictions for subsequent new input data.

Model trainer module 1118 is configured to compare, for each training data set 1114, the at least one output of the model to the at least one result data field of the training data set 1114, and apply a machine learning algorithm to adjust parameters of the model in order to reduce the difference or “error” between the at least one output and the corresponding at least one result data field. In this way, model trainer module 1118 trains the machine learning model to accurately predict the value of the at least one result data field.

In other words, model trainer module 1118 cycles the one or more machine learning models through the training data sets 1114, causing adjustments in the model parameters, until the error between the at least one output and the at least one result data field falls below a suitable threshold, and then uploads at least one trained machine learning model 1116 to operational predictive model module 1106 for application to generating predictions 1120. In example embodiments, model trainer module 1118 may be configured to simultaneously train multiple candidate machine learning models and to select the best performing candidate for each result data field, as measured by the “error” between the at least one output and the corresponding result data field, to upload to operational predictive model module 1106.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 1118 cycles through the training data sets 1114, model trainer module 1118 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 1118 provides an advantage by automatically discovering and properly weighting complex, second-or third order, and/or otherwise nonlinear interconnections between the model input data fields and the at least one output. Absent the machine learning model, such connections are unexpected and/or undiscoverable by human analysts.

In exemplary embodiments, operational predictive model module 1106 may compare feedback (e.g., feedback received from homeowners, and/or decisions made by homeowners based upon previous recommendations) and may route a comparison result 1122 generated by comparing prediction 1120 to the feedback to a model updater module 1124 of base computing device 110. Model updater module 1124 is configured to derive a correction signal 1126 from comparison results 1122 received for one or more predictions 1120, and to provide correction signal 1126 to model trainer module 1118 to enable updating or “re-training” of the at least one machine learning model to improve performance. The retrained at least one machine learning model 1116 may be periodically re-uploaded to operational predictive model module 1106.

Furthermore, base computing device 110 may use data from one or more external data sources 135 (shown in FIG. 1) as historical data 1104, training data sets 1114, validation data, and/or other data as needed during the training, retraining, and/or execution of the one or more AI models.

In some embodiments, base computing device trains multiple models, wherein each model is for analyzing a different device, device type, location, home type, and/or any other variation or division desired to improve the operation of response system 100 described herein.

### Exemplary Computer-Implemented Method

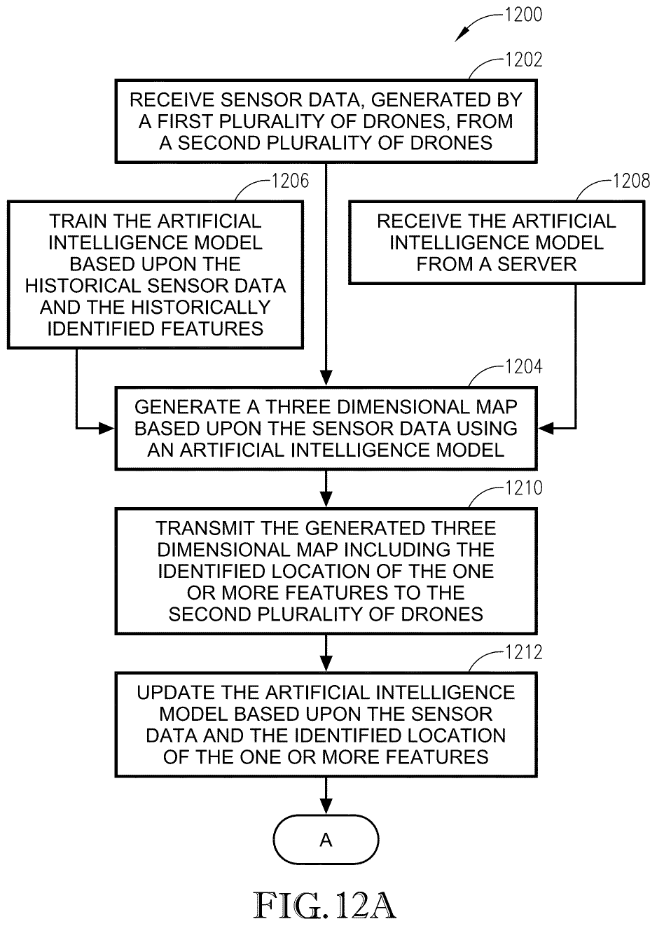

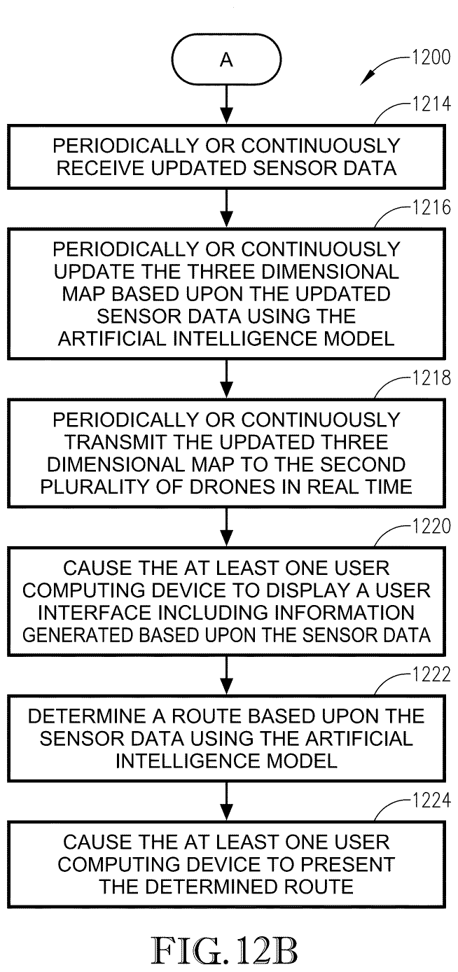

FIGS. 12A and 12B depict a flow chart of an exemplary computer-implemented method 1200 that may be implemented by the response system 100 (shown in FIG. 1). In the exemplary embodiment, computer-implemented method 1200 may be implemented by base computing device 110 in communication with a first plurality of drones (e.g., on-site drones 130) and a second plurality of drones (e.g., relay drones 125)

In the exemplary embodiment, computer-implemented method 1200 may include receiving (block 1202) sensor data, generated by a first plurality of drones, from a second plurality of drones. In some embodiments, the functionality described with respect to block 1202 may be performed by base computing device 110.

In the exemplary embodiment, computer-implemented method 1200 may further include generating (block 1204) a three dimensional map based upon the sensor data using an AI model. The AI model may be configured to identify a location of one or more features based upon the sensor data, and may be trained based upon historical sensor data and historically identified features. In some embodiments, the functionality described with respect to block 1204 may be performed by base computing device 110.

In some embodiments, computer-implemented method 1200 may further include training (block 1206) the AI model based upon the historical sensor data and the historically identified features. In some embodiments, the functionality described with respect to block 1206 may be performed by base computing device 110.

In certain embodiments, computer-implemented method 1200 may further include receiving (block 1208) the AI model from a server. The AI model received from the server may be trained at the server based at least in part upon historical sensor data received from a plurality of other base computing devices. In some embodiments, the functionality described with respect to block 1208 may be performed by base computing device 110.

In the exemplary embodiment, computer-implemented method 1200 may further include transmitting (block 1210) the generated three dimensional map including the identified location of the one or more features to the second plurality of drones. Each of the second plurality of drones may be configured to generate and transmit instructions for the first plurality of drones based upon the generated three dimensional map. In some embodiments, the functionality described with respect to block 1210 may be performed by base computing device 110.

In some embodiments, computer-implemented method 1200 may further include updating (block 1212) the AI model based upon the sensor data and the identified location of the one or more features. In some embodiments, the functionality described with respect to block 1212 may be performed by base computing device 110.

In certain embodiments, computer-implemented method 1200 may further include periodically or continuously receiving (block 1214) updated sensor data, periodically or continuously updating (block 1216) the three dimensional map based upon the updated sensor data using the AI model, and periodically or continuously transmitting (block 1218) the updated three dimensional map to the second plurality of drones in real time. In some embodiments, the functionality described with respect to block 1214, block 1216, and block 1218 may be performed by base computing device 110.

In some embodiments, computer-implemented method 1200 may further include causing (1220) the at least one user computing device to display a user interface including information generated based upon the sensor data. In some embodiments, the functionality described with respect to block 1220 may be performed by base computing device 110.

In certain embodiments, computer-implemented method 1200 may further include determining (block 1222) a route based upon the sensor data using the AI model and causing (block 1224) the at least one user computing device to present the determined route. In some embodiments, the functionality described with respect to block 1222 and block 1224 may be performed by base computing device 110.

### Artificial Intelligence and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as text, voice, image, mobile device, and/or telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

### Additional Considerations

Described herein are computer systems such as the disaster response computer devices and related computer systems. As described herein, all such computer systems include a processor and a memory. However, any processor in a computer device referred to herein can also refer to one or more processors wherein the processor can be in one computing device or a plurality of computing devices acting in parallel or as part of a distributed computing configuration. Additionally, any memory in a computer device referred to herein can also refer to one or more memories wherein the memories can be in one computing device or a plurality of computing devices acting in parallel.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (e.g., hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application-specific integrated circuits (ASICs), logic circuits, and any other circuit or processor capable of executing the functions described herein. The above examples are example only and are thus not intended to limit in any way the definition and/or meaning of the term “processor.”

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, CDMonk, New York; Microsoft is a registered trademark of Microsoft Corporation, Redmond, Washington; and Sybase is a registered trademark of Sybase, Dublin, California). The databases described herein may be located within and/or operatively connected to any part of any system described herein, and such location is not limited by what is shown in the figures.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some examples, the system includes multiple components distributed among a plurality of computer devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present examples can enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional embodiments that also incorporate the recited features.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The systems and processes are not limited to the specific examples described herein. In addition, components of each system and each process can be practiced independent and separate from other components and processes described herein. Each component and process also can be used in combination with other assembly packages and processes.

The patent claims at the end of this document are not intended to be construed under 35 U.S.C. § 112(f) unless traditional means-plus-function language is expressly recited, such as “means for” or “step for” language being expressly recited in the claim(s).

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein may include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A response system that utilizes a hierarchically-organized drone swarm, the response system comprising:
a first plurality of drones;
a second plurality of drones, wherein each one of the second plurality of drones is (i) in communication with at least one of the first plurality of drones, and (ii) configured to generate and transmit instructions for controlling the at least one of the first plurality of drones; and
a base computing device comprising at least one memory and at least one processor, the at least one processor in communication with the at least one memory and the second plurality of drones, the at least one processor configured to:
receive sensor data from the second plurality of drones, the sensor data generated by sensors of the first plurality of drones;
generate a three dimensional map based upon the sensor data using an artificial intelligence (AI) model, the AI model configured to identify a location of one or more features based upon the sensor data, wherein the AI model is trained based upon historical sensor data and historically identified features; and
transmit the generated three dimensional map including the identified location of the one or more features to the second plurality of drones, wherein each of the second plurality of drones is configured to generate and transmit the instructions based upon the generated three dimensional map.

2. The response system of claim 1, wherein the at least one processor is further configured to train the AI model based upon the historical sensor data and the historically identified features.

3. The response system of claim 1, wherein the at least one processor is further configured to update the AI model based upon the sensor data and the identified location of the one or more features.

4. The response system of claim 1, wherein the at least one processor is further configured to receive the AI model from a server, wherein the AI model is trained at the server based at least in part upon historical sensor data received from a plurality of other base computing devices.

5. The response system of claim 1, wherein the at least one processor is further configured to:
periodically or continuously receive updated sensor data;
periodically or continuously update the three dimensional map based upon the updated sensor data using the AI model; and
periodically or continuously transmit the updated three dimensional map to the second plurality of drones in real time.

6. The response system of claim 1, wherein at least one of the first plurality of drones or the second plurality of drones is configured to deploy from a vehicle.

7. The response system of claim 6, wherein at least a portion of the at least one processor is executed onboard the vehicle.

8. The response system of claim 1, wherein at least one of the second plurality of drones comprises at least one sensor.

9. The response system of claim 1, wherein at least one of the first plurality of drones is configured to deploy from one of the second plurality of drones.

10. The response system of claim 1, wherein at least one of the first plurality of drones includes one or more of a camera, an audio sensor, a thermal sensor, a chemical sensor, or an electrical sensor.

11. The response system of claim 1, wherein at least one of the first plurality of drones includes at least one mechanical device configured to move objects.

12. The response system of claim 1, wherein at least one of the first plurality of drones is configured to one or more of supply charge to another one of the first plurality of drones or exchange a battery of another one of the first plurality of drones.

13. The response system of claim 1, wherein the at least one processor is further in communication with at least one user computing device, and wherein the at least one processor is further configured to cause the at least one user computing device to display a user interface including information generated based upon the sensor data.

14. The response system of claim 13, wherein the at least one processor is further configured to:
determine a route based upon the sensor data using the AI model; and
cause the at least one user computing device to present the determined route.

15. A computer-implemented method for operating a response system that utilizes a hierarchically-organized drone swarm, the response system including a first plurality of drones, a second plurality of drones, and a base computing device, wherein each one of the second plurality of drones is (i) in communication with at least one of the first plurality of drones and the base computing device, and (ii) configured to generate and transmit instructions for controlling the at least one of the first plurality of drones, the computer-implemented method comprising:
receiving, by the base computing device, sensor data from the second plurality of drones, the sensor data generated by sensors of the first plurality of drones;
generating, by the base computing device, a three dimensional map based upon the sensor data using an artificial intelligence (AI) model, the AI model configured to identify a location of one or more features based upon the sensor data, wherein the AI model is trained based upon historical sensor data and historically identified features; and
transmitting, by the base computing device the generated three dimensional map including the identified location of the one or more features to the second plurality of drones, wherein each of the second plurality of drones is configured to generate and transmit the instructions based upon the generated three dimensional map.

16. The computer-implemented method of claim 15, further comprising training, by the base computing device, the AI model based upon the historical sensor data and the historically identified features.

17. The computer-implemented method of claim 15, furth comprising updating, by the base computing device, the AI model based upon the sensor data and the identified location of the one or more features.

18. The computer-implemented method of claim 15, further comprising receiving, by the base computing device, the AI model from a server, wherein the AI model is trained at the server based at least in part upon historical sensor data received from a plurality of other base computing devices.

19. The computer-implemented method of claim 15, further comprising:
periodically or continuously receiving, by the base computing device, updated sensor data;
periodically or continuously updating, by the base computing device, the three dimensional map based upon the updated sensor data using the AI model; and
periodically or continuously transmitting, by the base computing device, the updated three dimensional map to the second plurality of drones in real time.

20. At least one non-transitory computer-readable media having computer-executable instructions embodied thereon, wherein when executed by a base computing device including at least one processor, the at least one processor in communication with a plurality of relay drones, wherein each one of the plurality of relay drones is (i) in communication with at least one of a plurality of on-site drones and (ii) configured to generate and transmit instructions for controlling the at least one of the plurality of on-site drones, the computer-executable instructions cause the at least one processor to:
receive sensor data from the plurality of relay drones, the sensor data generated by sensors of the plurality of on-site drones;
generate a three dimensional map based upon the sensor data using an artificial intelligence (AI) model, the AI model configured to identify a location of one or more features based upon the sensor data, wherein the AI model is trained based upon historical sensor data and historically identified features; and
transmit the generated three dimensional map including the identified location of the one or more features to the plurality of relay drones, wherein each of the plurality of relay drones is configured to generate and transmit the instructions based upon the generated three dimensional map.
